(19) United States
(12) Patent Application Publication
(10) Pub. No.: US 2022/0083724 A1
(43) Pub. Date: Mar. 17, 2022

(54) METHODS AND SYSTEMS FOR ASSISTING DOCUMENT EDITING

(71) Applicant: QIXINGTIAN (BEIJING) CONSULTING COMPANY LTD., Beijing (CN)

(72) Inventor: Yan LI, Suzhou (CN)

(73) Assignee: QIXINGTIAN (BEIJING) CONSULTING COMPANY LTD., Beijing (CN)

(21) Appl. No.: 17/447,576

(22) Filed: Sep. 13, 2021

(30) Foreign Application Priority Data
Sep. 14, 2020 (CN) 202010963770.1

(51) Int. Cl. G06F 40/166; G06F 40/279; G06F 40/197; G06F 40/14; G06N 3/04

(52) U.S. Cl. CPC G06F 40/166; G06F 40/279; G06N 3/04; G06F 40/14; G06F 40/197

(57) ABSTRACT

The present disclosure discloses a method of assisting document editing which is applied to a client. The method may include receiving and displaying a text structure of a second text obtained by a server based on a first text. The first text may include at least one discussion, each of the at least one discussion including at least one key point. The text structure of the second text may be a tree structure, and may include at least one structure node corresponding to the at least one discussion or the at least one key point. The second text may include at least one text unit corresponding to the at least one structure node, the at least one text unit being configured to illustrate the first text. The method may also include generating a request of acquiring a target text unit corresponding to the at least one structure node when the at least one structure node is detected to be triggered, and sending the request to the server; and receiving and displaying the target text unit obtained by the server.

### CROSS-REFERENCE TO RELATED APPLICATIONS

This application claims priority to Chinese Patent Application No. 202010963770.1, filed on Sep. 14, 2020, the contents of which are hereby incorporated by reference.

### TECHNICAL FIELD

The present disclosure relates to information processing, and in particular, to methods and systems for assisting document editing.

### BACKGROUND

With the rapid development of science and technology and the rapid update of knowledge, a large number of documents are needed for technical communication and knowledge dissemination. Due to the weak writing ability and limited editing time, some people have low efficiency in editing documents and the quality of documents is poor.

Therefore, there is an urgent need of methods and systems for assisting document editing to improve the efficiency of document editing and the quality of edited documents.

### SUMMARY

One aspect of embodiments of the present disclosure provides a method for assisting document editing, applied to a client. The method may include receiving and displaying a text structure of a second text obtained by a server based on a first text. The first text may include at least one discussion, each of the at least one discussion including at least one key point; the text structure of the second text may be a tree structure, and may include at least one structure node corresponding to the at least one discussion or the at least one key point, the at least one structure node being generated by manual input or by a structure node generating model. The structure node generating model may be a machine learning model, whose input feature includes content features of a superior-level structure node of the at least one structure node and content features of a same-level structure node of the at least one structure node, the content features of the superior-level structure node or the content features of the same-level structure node including one or more features of the superior-level structure node or the same-level structure node: a corresponding discussion, a corresponding key point, a type of a corresponding text unit, or a related requirement of the corresponding text unit, of the superior-level structure node or the same-level structure node; the second text may include at least one text unit corresponding to the at least one structure node, the at least one text unit being configured to illustrate the first text. The method may also include generating a request of acquiring a target text unit corresponding to the at least one structure node when the at least one structure node is detected to be triggered, and sending the request to the server; and receiving and displaying the target text unit obtained by the server.

Another aspect of embodiments of the present disclosure may provide a system for assisting document editing. The system may include a text structure receiving module configured to receive and display a text structure of a second text obtained by a server based on a first text. The first text may include at least one discussion, each of the at least one discussion including at least one key point; the text structure of the second text may be a tree structure, and may include at least one structure node corresponding to the at least one discussion or the at least one key point, the at least one structure node being generated by manual input or by a structure node generating model. The structure node generating model may be a machine learning model, whose input feature includes content features of a superior-level structure node of the at least one structure node and content features of a same-level structure node of the at least one structure node, the content features of the superior-level structure node or the content features of the same-level structure node including one or more features of the superior-level structure node or the same-level structure node: a corresponding discussion, a corresponding key point, a type of a corresponding text unit, or a related requirement of the corresponding text unit of the superior-level structure node or the same-level structure node; the second text may include at least one text unit corresponding to the at least one structure node, the at least one text unit being configured to illustrate the first text. The system may also include a text unit requesting module configured to generate a request of acquiring a target text unit corresponding to the at least one structure node when the at least one structure node is detected to be triggered, and send the request to the server; and a text unit displaying module configured to receive and display the target text unit obtained by the server.

Another aspect of embodiments of the present disclosure may provide a method for assisting document editing, applied to a server. The method may include obtaining a first text, the first text including at least one discussion, each of the at least one discussion including at least one key point; obtaining a text structure of a second text based on the first text. The text structure of the second text may be a tree structure, and include at least one structure node corresponding to the at least one discussion or the at least one key point, the at least one structure node being generated by manual input or by a structure node generating model. The structure node generating model may be a machine learning model, whose the input feature includes content features of a superior-level structure node of the at least one structure node and content features of a same-level structure node of the at least one structure node, the content features of the superior-level structure node or the content features of the same-level structure node including one or more of features of the superior-level structure node or the same-level structure node: a corresponding discussion, a corresponding key point, a type of a corresponding text unit, or a related requirement of the corresponding text unit, of the superior-level structure node or the same-level structure node; the second text may include at least one text unit corresponding to the at least one structure node, the at least one text unit being configured to illustrate the first text. The method may also include sending the text structure of the second text to a client; receiving a request of acquiring a target text unit corresponding to the at least one structure node generated by the client; and in response to the request, obtaining the target text unit and sending it to the client.

Another aspect of embodiments of the present disclosure may provide a system for assisting document editing. The system may include a first text obtaining module configured to obtain a first text, the first text including at least one discussion, each of the at least one discussion including at least one key point; a text structure generating module configured to obtain a text structure of a second text based on the first text. The text structure of the second text may be a tree structure, and include at least one structure node corresponding to the at least one discussion or the at least one key point, the at least one structure node being generated by manual input or by a structure node generating model generation. The structure node generating model may be a machine learning model, whose the input feature includes content features of a superior-level structure node of the at least one structure node and content features of a same-level structure node of the at least one structure node, the content features of the superior-level structure node or the content features of the same-level structure node including one or more features of the superior-level structure node or the same-level structure node: a corresponding discussion, a corresponding key point, a type of a corresponding text unit, or a related requirement of the corresponding text unit, of the superior-level structure node or the same-level structure node; the second text may include at least one text unit corresponding to the at least one structure node, the at least one text unit being configured to illustrate the first text. The system may also include a text structure sending module configured to send the text structure of the second text to a client; a request receiving module configured to receive a request of acquiring a target text unit corresponding to the at least one structure node generated by the client, and a text unit sending module configured to obtain the target text unit and send it to the client in response to the request.

Another aspect of embodiments of the present disclosure may provide a computer readable storage medium. The storage medium may store computer instructions, wherein when executed by a processor, the computer instructions direct the processor to perform the method described above.

### BRIEF DESCRIPTION OF THE DRAWINGS

The present disclosure is further describable in terms of exemplary embodiments. These exemplary embodiments are describable in detail with reference to the drawings. These embodiments are non-limiting exemplary embodiments, in which like reference numerals represent similar structures throughout the several views of the drawings, and wherein:

FIG. 1 is a schematic diagram illustrating an exemplary application scenario of a system for assisting document editing according to some embodiments of the present disclosure;

FIG. 2 is a flowchart illustrating an exemplary method for assisting document editing that may be applied to a server according to some embodiments of the present disclosure;

FIG. 3 is a flowchart illustrating an exemplary method for assisting document editing that may be applied to a client according to some embodiments of the present disclosure;

FIG. 4 is a schematic diagram illustrating assisting document editing according to some embodiments of the present disclosure;

FIG. 5 is a flowchart illustrating an exemplary method for generating a structure node by a structure node generating model according to some embodiments of the present disclosure;

FIG. 6 is a flowchart illustrating an exemplary method for editing a text unit according to some embodiments of the present disclosure;

FIG. 7a is a schematic diagram illustrating editing a text unit according to some embodiments of the present disclosure;

FIG. 7b is a schematic diagram illustrating displaying differences of versions of text structures according to some embodiments of the present disclosure; and

FIG. 7c is a schematic diagram illustrating displaying differences of versions of text units according to some embodiments of the present disclosure.

### DETAILED DESCRIPTION

In order to illustrate the technical solutions related to the embodiments of the present disclosure, brief introduction of the drawings referred to in the description of the embodiments may be provided below. Obviously, drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “systems,” “devices,” “unit,” and/or “modules” used herein are a manner for distinguishing different components, elements, components, parts, or assemblies in different levels. However, if other words may achieve the same purpose, the words may be replaced by other expressions.

As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments in the present disclosure. It may be to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

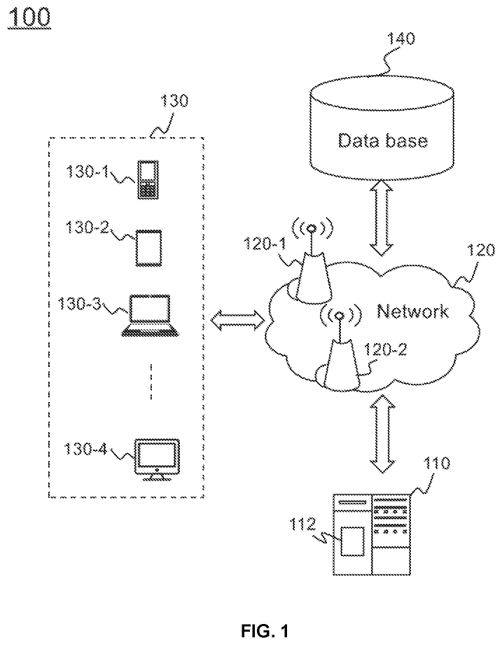

FIG. 1 is a schematic diagram illustrating an exemplary application scenario of a system for assisting document editing according to some embodiments of the present disclosure.

The system for assisting document editing may generate a text structure of a second text of a document based on a first text of the document, and assist a user in editing a text unit of the second text. For example, the system for assisting document editing may generate an outline of a specification based on claims of a patent application document, and assist the user in editing the specification. As another example, the system for assisting document editing may generate an analysis outline based on an analysis conclusion of an enterprise analysis report, and assist the user in editing an analysis content.

As shown in the application scenario 100 of FIG. 1, the system for assisting document editing may include a server 110, a network 120, a client 130, and a data base 140. The server 110 may include a processing device 112.

In some embodiments, the server 110 may be configured to process information and/or data related to data processing. In some embodiments, the server 110 may access information and/or information stored in the client 130 and the data base 140 over the network 120. For example, the server 110 may acquire the first text in the data base 140 over the network 120. For example, the server may receive a first text input by a user through the client 130 over the network 120. In some embodiments, the server 110 may be directly connected to the client 130 and/or data base 140 to access information and/or data stored therein. For example, the server 110 may receive a request of acquiring a target text unit (also referred to as acquisition request) corresponding to structure node(s) generated by the client 130. The server 110 may be a stand-alone server or server group. The server group may be a centralized or distributed (e.g., the server 110 may be a distribution system). In some embodiments, the server 110 may be regional or remote. In some embodiments, the server 110 may be executed on a cloud platform. For example, the cloud platform may include a private cloud, a public cloud, a hybrid cloud, a community cloud, a distributed cloud, an inter-cloud, a multi-cloud, or the like, or a combination thereof.

In some embodiments, the server 110 may include the processing device 112. The processing device 112 may process data and/or information to perform one or more functions described in this disclosure. For example, the processing device 112 may obtain a plurality of sets of sample data based on completed documents to obtain a structure node generating model by training. For example, based on the first text, the processing device 112 may obtain the text structure of the second text by a trained structure node generating model. For example, the processing device 112 may acquire a target text unit and send it to the client 130 in response to the acquisition request. In some embodiments, the processing device 112 may include one or more sub-processing devices (e.g., single-core processing devices or multi-core processing devices). For example, the processing device 112 may include a central processing unit (CPU), an application specific integrated circuit (ASIC), an application specific instruction processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction set computing (RISC), a microprocessor, or the like, or any combination of the above.

In some embodiments, the network 120 may promote exchanging of data and/or information. The data or information may include a first text, a type of a text unit, requirements of the text unit, and a second text. In some embodiments, one or more components (e.g., the server 110, the client 130, the data base 140) of the system for assisting document editing in the application scenario 100 may send data and/or information to other components of the system for assisting document editing in the application scenario 100 via the network 120. In some embodiments, the network 120 may be any type of wired or wireless networks. For example, the network 120 may include a cable network, a wired network, a fiber optic network, a telecommunications network, an internal network, an internet, a local area network (LAN), a wide area network (WAN), a wireless local area network (WLAN), metro area networks (MAN), a public phone exchange network (PSTN), Bluetooth Network, ZigBee Network, Near Field Communication (NFC) network, or the like, or any combination of the above. In some embodiments, the network 120 may include one or more network access points. For example, the network 120 may include wired and/or wireless network access points such as base stations and/or internet exchange points 120-1, 120-2, . . . , through which one or more components of the system for assisting document editing in the application scenario 100 may be connected to the network 120 to exchange data and/or information.

In some embodiments, the client 130 may be a computing device or a computing device group. In some embodiments, the client 130 has an input function for a user to input data, for example, enter the first text, enter a content of the text unit of the second text. The computing device may include one or more of a mobile phone 130-1, a tablet 130-2, a laptop 130-3, a desktop computer 130-4, or the like. The computing device group may be centralized or distributed. In some embodiments, the client 130 may send the input first text to the server 110. Accordingly, the server 110 may determine the text structure of the second text and send the text structure of the second text to the client 130 based on the input first text. In some embodiments, the client 130 has a display function for displaying the text structure and target text unit of the second text acquired by the server 110.

In some embodiments, the system for assisting document editing may include: a text structure receiving module, a text unit requesting module, a text unit displaying module, and a second text sending module.

The text structure receiving module may be configured to receive and display a text structure of a second text obtained by a server based on a first text. The first text may include at least one discussion, each of which may include at least one key point.

In some embodiments, the text structure of the second text may be a tree structure, and may include at least one structure node corresponding to the at least one discussion or the at least one key point, the at least one structure node being generated by manual input or by a structure node generating model. The structure node generating model may be a machine learning model, whose input feature includes content features of a superior-level structure node of the at least one structure node and content features of the same-level structure node of the at least one structure node. In some embodiments, the content features of the superior-level structure node or the content features of the same-level structure node may include one or more features of the superior-level structure node or the same-level structure node: a corresponding discussion, a corresponding key point, a type of a corresponding text unit, or a related requirement of the corresponding text unit, of the superior-level structure node or the same-level structure node. In some embodiments, the content features of the superior-level structure node or the content features of the same-level structure may include a key point type feature of the key point corresponding to the superior-level structure node or the same-level structure node. The structure node generating model may be a neural network model and may be generated by training. In some embodiments, key point type feature may be obtained by a key point type judging model. The key point type judging model may be a machine learning model, and may include an embedded sub-model and a classification sub-model. The embedded sub-model may generate a key point text representing vector based on a key point text, and the classification sub-model may generate the key point type feature based on the key point text representing vector.

In some embodiments, the second text may include at least one text unit corresponding to at least one structure node, at least one text unit may be configured to illustrate the first text.

The text unit requesting module may be configured to detect the request (also referred to as acquisition request) of acquiring the target text unit corresponding to the structure node, and sends the request to the server.

The text unit displaying module may be configured to receive and display a target text unit obtained by the server. In some embodiments, the text unit displaying module may be further configured to display a plurality of neighboring text units of the target text unit, obtain a modification instruction to the target text unit. After performing the modification instruction, the text unit displaying module may be configured to display an updated target text unit. In some embodiments, the text unit displaying module may be also configured to display differences of a plurality of versions of the text structure of the second text provided by the server, and display differences of a plurality of versions of the text unit of the second text provided by the server.

The second text sending module may be configured to send the current version of second text to the server based on a saved trigger condition.

In some embodiments, the system for assisting document editing may include: a first text obtaining module, a text structure generating module, a text structure sending module, a request receiving module, a text unit sending module, a second text obtaining module, and a version difference determining module.

The first text obtaining module may be configured to obtain the first text, and the first text may include at least one discussion, each of the at least one discussion including at least one key point.

The text structure generating module for obtaining a text structure of a second text based on the first text.

In some embodiments, the text structure of the second text may be a tree structure, and may include at least one structure node corresponding to at least one discussion and/or the at least one key point, the structure node being generated by manual input or by a structure node generating model. The structure node generating model may be a machine learning model, whose input features may include content features of a superior-level structure node of the structure node and content features of a same-level structure node of the structure node.

In some embodiments, the second text also may include at least one text unit corresponding to at least one structure node, at least one text unit being configured to illustrate the first text.

The text structure sending module may be configured to send a text structure for the second text to the client.

The request receiving module may be requested to receive a request of acquiring a target text unit corresponding to the structure node generated by the client.

The text unit sending module may be configured to obtain the target text unit and sending the target text unit to the client in response to the request.

The second text obtaining module may be configured to receive a current version of the second text from the client.

The version difference determining module may be configured to determine differences of a plurality of versions of the text structure of the second text and send them to the client, and determine differences of a plurality of versions of the text unit of the second text and send them to the client.

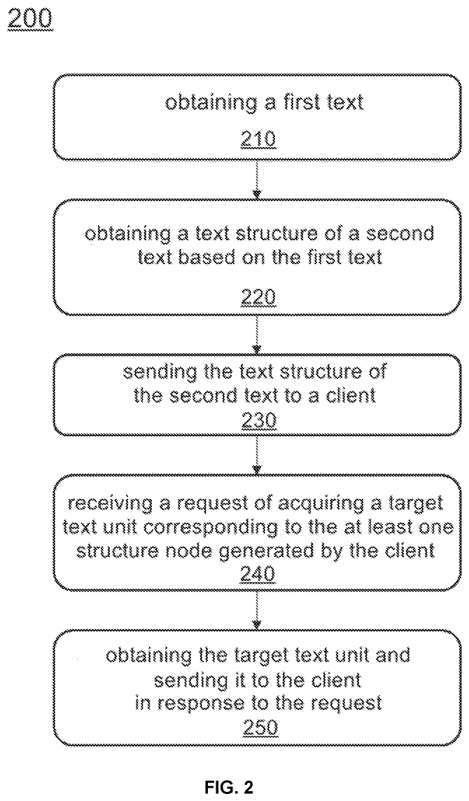

FIG. 2 is a flowchart illustrating an exemplary method for assisting document editing that may be applied to a server according to some embodiments of the present disclosure.

A document may be a character set describing analysis results and/or research results. In some embodiments, the document may be a report of analyzing rules and phenomena, for example, enterprise analysis reports, market analysis reports, economic analysis reports, and social issues analysis reports. In some embodiments, the document may be a solution for solving technical problems, for example, product designs, engineering technology solutions, management solutions, or the like. In some embodiments, the document may be a summary of academic research, for example, academic papers, patent application document, or the like.

In some embodiments, the document may include a first text and a second text. The first text may be a summary, conclusion, and/or contention of the document. The second text may be an elaboration, description, and/or demonstration of the document. For example, if the document is an enterprise analysis report, the first text may be an analysis conclusion, and the second text may be a description for the analysis conclusion. For example, if the document is a patent application document, the first text may be claims, and the second text may be a specification.

As shown in FIG. 2, the method 200 for assisting document editing, applied to the server, may include the following steps.

In step 210, the first text may be obtained. Specifically, step 210 may be executed by the first text obtaining module.

As mentioned earlier, the first text may be a summary, conclusion, and/or contention of the document.

In some embodiments, the first text may include at least one discussion. Each discussion may characterize one aspect of the first text. In some embodiments, each discussion may include at least one key point. The key point may be the main content of the discussion, and each key point may characterize a point of the discussion.

Taking an enterprise analysis report as an example, the first text may be an analysis conclusion, including three discussions such as discussion 1, discussion 2, and discussion 3. Discussion 1 may be an analysis conclusion of enterprise's operation, discussion 2 may be an analysis conclusion of enterprise's financial situation, and discussion 3 may be an evaluation conclusion of enterprise's value. Discussion 1 may include two key points such as key point 1 and key point 2. Key point 1 may be production of an enterprise, and key point 2 may be sales performance of an enterprise.

Taking a patent application document as an example, the first text may be the claims, including three discussions, such as claims 1, claim 2, and claim 3. Claim 1 may include two key points, such as, two different technical features.

In some embodiments, the server may obtain the first text from input through the client, or by reading the storage data, calling associated interfaces, or other ways.

In step 220, based on the first text, a text structure of the second text may be obtained. Specifically, step 220 may be executed by the text structure generating module.

As mentioned earlier, the first text may be a summary, conclusion, and/or contention of the document, and the second text may be an elaboration, explanation, and/or demonstration of the document. It will be appreciated that the second text may be used to illustrate the first text. For example, an analytical description of an enterprise analysis report may be used to illustrate the analysis conclusions. As another example, the specification of the patent application document may be used to illustrate the claims.

The text structure refers to the layout of the second text, for example, content outlines and headings. In some embodiments, the text structure may include a summary of contents and a level of position of the second text. In some embodiments, the text structure may be a tree structure, and include at least one structure node corresponding to at least one discussion and/or at least one key point.

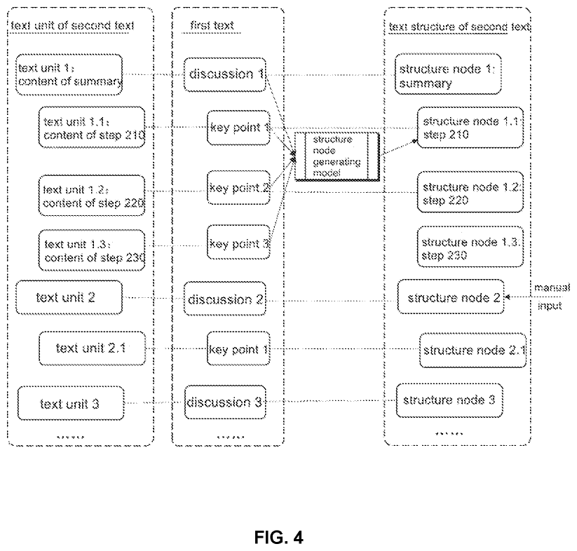

The structure node may characterize the summary of contents of the second text. With FIG. 4 as an example, the structure node 1.1 of “step 210” may characterize that “step 210” may be illustrated by the second text. In some embodiments, the structure node may correspond to the discussion and/or key points of the first text. Taking the patent application document in FIG. 4 as an example, the structure node 1 of “summary” may correspond to claim 1 (that is, discussion 1) in the claims (that is, the first text). The structure node 1.1 of “step 210” may correspond to a technical feature (that is, key point 1) of claim 1 (that is, discussion 1) in the claims (that is, the first text), characterizing that the discussion 1 and key point 1 of the first text may be explained by the second text.

The tree structure may characterize a level of position of a structure node, and accordingly may characterize the level of position of the corresponding second text. As shown in FIG. 4, the structure node 1.1 of “step 220”, the structure node 1.2 of “step 220,” and the structure node 1.3 of “step 230” may be sub-nodes of the structure node 1 of “summary”. Therefore, the position of structure node 1.1, the position of the structure node 1.2, and the position of structure node 1.3 may be in the same level, which may be regarded as same-level structure nodes. Correspondingly, positions of “content of step 210”, “content of step 220” and “content of step 230” of second text may be also in the same level. The position of structure node 1 of “summary” may be in the superior level. Thus, the position of structure node 1 of “summary” may be a superior-level structure node of structure node 1.1, structure node 1.2, and structure node 1.3. Correspondingly, the “content of summary” in the second text may be also in the superior level. In some embodiments, the same-level structure node of a structure node may include the structure node itself. For example, the same-level structure node of the structure node 1.1 may include not only structure node 1.2 and structure node 1.3, but also include structure node 1.1.

In some embodiments, the structure node may be generated by manual input. Specifically, the structure node and its level of position may be manually inputted based on the discussion and/or key points of the first text.

In some embodiments, the structure node may be generated by a structure node generating model. The structure node generating model may be a machine learning model, whose input feature may include content features of a superior-level structure node of the structure node and content features of a same-level structure node of the structure node. It should be understood that when the structure node is a primary structure node, which has no corresponding superior structure node, the input feature may include only the content features of the same-level structure node. The related description of the structure nodes generated by the structure node generating model may be seen at FIG. 4, and not described herein.

In some embodiments, the second text may include at least one text unit corresponding to at least one structure node. The text unit may be a constituent element of the second text, and the second text may be divided into different text units based on different contents. It should be understood that each text unit may correspond to a structure node. The text unit of the second text may be configured to illustrate the first text, that is, the second text may be configured to illustrate the first text. Detailed description of the text unit may be found in step 320, and not be described herein.

In step 230, the text structure of the second text may be sent to the client. Specifically, step 230 may be executed by the text structure sending module.

In some embodiments, the server may send the text structure of the second text to the client. The text structure of the second text may include structure nodes and a tree structure.

In step 240, a request of acquiring a target text unit corresponding to the structure node generated by the client may be received. Specifically, step 240 may be executed by the request receiving module.

The target text unit corresponding to the structure node may be a text unit corresponding to the structure node that triggered by the user on the user interface of the client. Detailed description of the target text unit may be found in step 320, and not described herein.

In some embodiments, the server may receive the acquisition request sent by the client. For example, the server may receive the acquisition request of the target text unit of “content of step 220” sent by the client.

In step 250, the target text unit may be obtained and sent to the client in response to the acquisition request. Specifically, step 250 may be executed by the text unit sending module.

In some embodiments, the server may obtain the target text unit by reading the data base, calling associated infaces or other ways in response to the acquisition request.

It should be understood that the target text unit stored in the data base may be a blank text unit generated by the server or a text unit that is saved after being edited by the user. In some embodiments, after obtaining the text structure of the second text based on the first text (step 220), the server may generate a blank text unit corresponding to each structure node in the text structure, and may store the text structure and the blank text unit in the data base. In some embodiments, the server may also obtain, from the client, the text unit of the second text saved after the text unit is edited by the user, and store the saved text units in the data base.

The server may send the target text unit to the client.

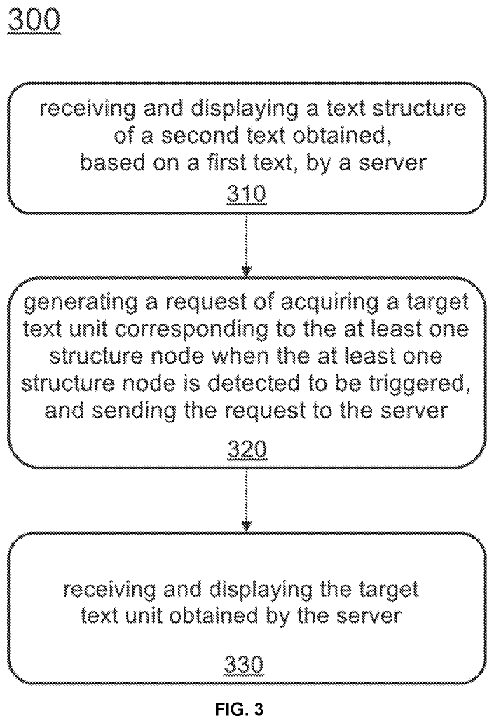

FIG. 3 is a flowchart illustrating an exemplary method for assisting document editing that may be applied to a client according to some embodiments of the present disclosure. As shown in FIG. 3, the method 300 for assisting document editing may include the following steps:

In step 310, the text structure of the server based on the second text acquired by the first text may be received and displayed. Specifically, step 310 may be executed by the text structure receiving module.

In some embodiments, the client may receive the text structure of the second text obtained by the server based on the first text. Detailed description of obtaining the second text by the server based on the first text may be found in step 220, and details may not be described herein.

In some embodiments, the received text structure may be displayed on a user interface of the client, and the received text structure may include structure nodes, and tree structures. In some embodiments, the user interface may display all or a part of the text structure based on a user's operation. For example, the operation may include folding (represented by “−”), unfolding (represented by “+”), scrolling (represented by a two-way arrow) and zoom, or the like.

In some embodiments, the second text also may include at least one text unit corresponding to at least one structure node. The text unit may be a constituent element of the second text, and the second text may be divided into different text units in different contents. Taking the patent application document shown in FIG. 4 as an example, in order to further illustrate the claim 1 corresponding to the text unit 1, the content of the second text may be divided into three text units: text unit 1.1, text unit 1.2, and text unit 1.3 according to “content of step 210”, “content of step 220,” and “content of step 230”. The text unit 1.1, the text unit 1.2, and the text unit 1.3 may be respectively used to illustrate the three technical features of claim 1.

In some embodiments, each text unit may correspond to a structure node. As shown in FIG. 4, the text unit 1.1 of “step 210” may correspond to the structure node 1.2 of “step 220”, the text unit 1.2 of “step 220” may correspond to the structure node 1.2 of “step 220”, the text unit 1.3 of “content of step 230” may correspond structure node 1.3 of “step 230”.

The text unit of the second text may be configured to illustrate the first text, that is, the second text may be configured to illustrate the first text. It should be understood that the text unit corresponding to the structure node may be configured to illustrate the discussion and/or key point of the first text corresponding to the structure node. Taking the patent application document shown in FIG. 4 as an example, the structure node 1 of “summary” may correspond to the claim 1 (e.g., discussion 1) in claims, and the corresponding text unit 1 of “content of summary” may be configured to illustrate claim 1 (discussion 1). Structure node 1.1 of “step 210” may correspond to the technical feature 1 (e.g., key point 1) of claim 1 (e.g., discussion 1) of claims (e.g., the first text), and the corresponding text unit 1.1 of “content of step 210” may be configured to illustrate technical feature 1 (e.g., key point 1).

In step 320, when the structure node is detected to be triggered, a request of acquiring a target text unit corresponding to the structure node may be generated, and the request may be sent to the server. Specifically, step 320 may be executed by a text unit requesting module.

As mentioned above, the structure node may represent the summary of contents of the second text. Detailed description of the structure node may be found in step 220, and not described herein.

The target text unit corresponding to the structure node may be a text unit corresponding to the triggered structure node. In some embodiments, the client may detect whether the user has performed a trigger operation on the structure node displayed by the user interface. In some embodiments, the trigger operation may include, but not limited to: clicking, double-clicking, selecting, touching, and gesture inputting, or the like. Specifically, when the user triggers the structure node displayed on the user interface, the client may detect the trigger operation on the user interface, and generate the request of acquiring the target text unit corresponding to the structure node.

In some embodiments, the client may send the request to the server.

For example, when the user clicks the structure node of “step 220” displayed on the user interface, the client may detect that the structure node of “step 220” is triggered, and generate the request of acquiring the target text unit “step 220” and send the request to the server.

In step 330, the target text unit obtained by the server may be received and displayed. Specifically, step 330 may be executed by the text unit displaying module.

In some embodiments, the client may receive the target text unit obtained by the server. The detailed description of the target text unit obtained by the server may be found in step 250, and not described herein.

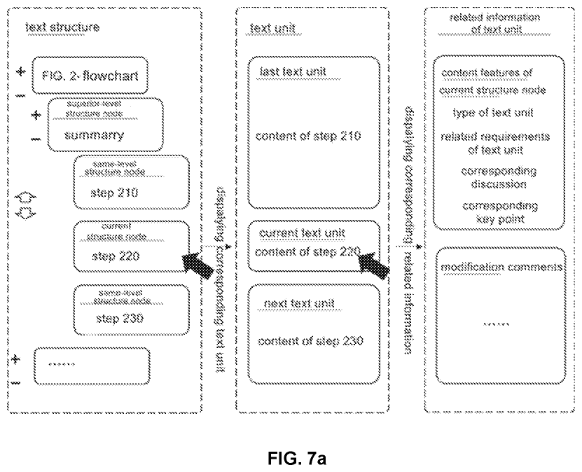

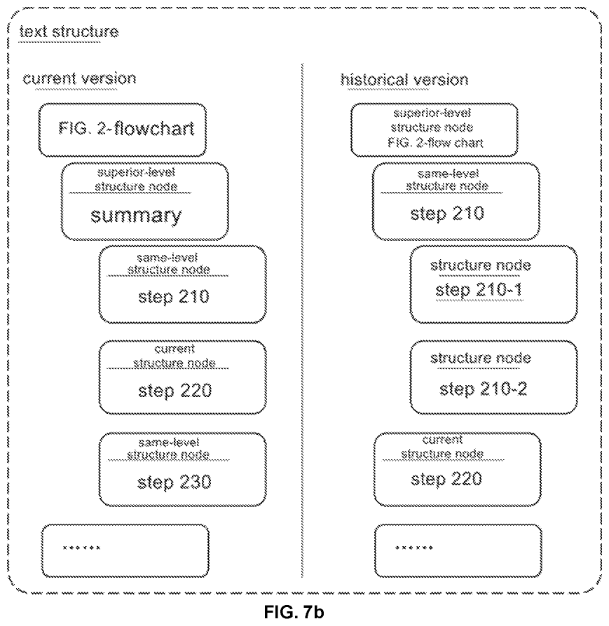

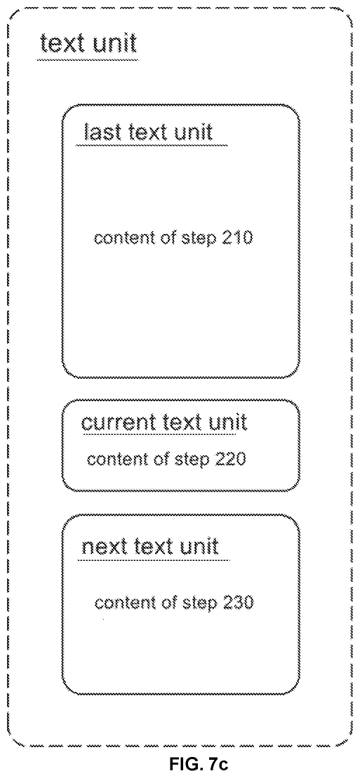

Further, after the client receives the target text unit, the target text unit may be displayed on the user interface so that the user may edit the content of the target text unit on the user interface. As shown in FIG. 7a, the user may click the structure node of “step 220” on the user interface of the client, the client may detect a trigger operation such as “clicking”, obtain the content of the target text unit of “content of step 220” corresponding to the structure node of “step 220”, and display the target text unit on the user interface. The content of the target text unit may be an edited content, or blank content that is not edited.

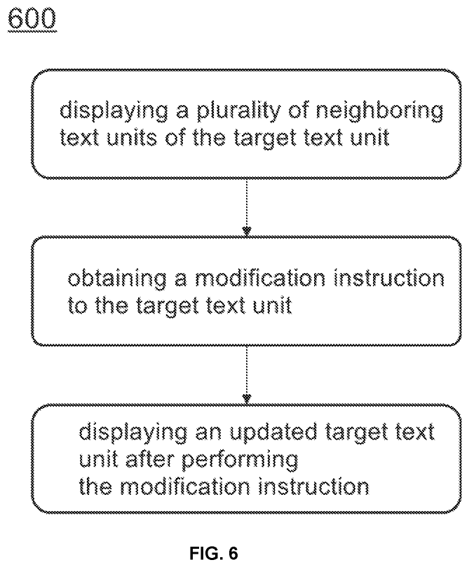

Related descriptions of editing the content of the text unit may be found in FIG. 6, and not described herein.

The above embodiments may provide at least one beneficial effect of followings. The text unit may be edited based on the text structure, making the second text structuralized and making the characteristic of the text unit corresponding to each structure node clear, thereby adjusting the text structure flexibly and conveniently. Further, based on a clear data structure, structure node(s) can be generated through a machine learning model, thus improving the writing efficiency and document quality.

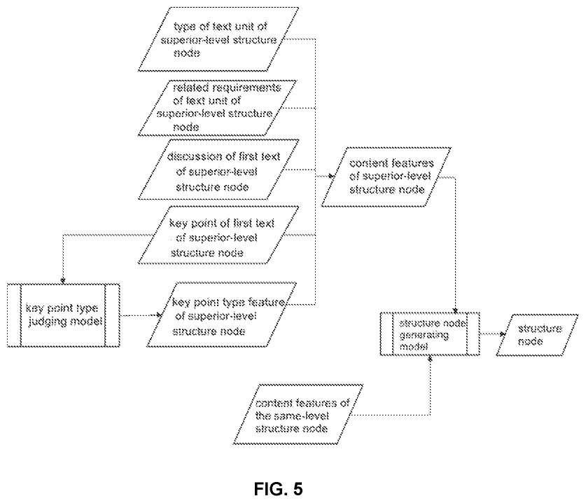

FIG. 5 is a flowchart illustrating an exemplary method for generating a structure node by a structure node generating model according to some embodiments of the present disclosure.

The structure node generating model may generate a structure node. As described above, in some embodiments, in order to generate the structure node based on the structure node generating model, content features of the superior-level structure node and content features of the same-level structure node of the structure node may be inputted into the structure node generating model to output the structure node.

The superior-level structure node may be a parent node of the structure node, and the same-level structure node may have a same parent node with the structure node. Taking FIG. 4 as an example, in order to generate a structure node 1.2 of “step 220”, as previously described, the input of the structure node generating model may include the superior-level structure node including content features of structure node 1, and the same-level structure node including content features of structure node 1.1, content features of structure node 1.2, and content features of structure node 1.3.

The content feature of the structure node refers to the basis of the content source of the structure node. In some embodiments, the content features of the superior-level structure node or the content features of the same-level structure node may include one or more features of the superior-level structure node or the same-level structure node: a corresponding discussion, a corresponding key point, a type of a corresponding text unit, or a related requirement of the corresponding text unit of the superior-level structure node or the same-level structure node. It should be understood that the content features of the same-level structure node may include the above-described features corresponding to the same-level structure node, and the content features of the superior-level structure node may include the above-described features corresponding to the superior-level structure node.

As mentioned above, the superior-level structure node may correspond to the discussions and/or key points of the first text, wherein each discussion may represent one aspect of the first text, and each key point may represent a point of the discussion. As shown in FIG. 4, the superior-level structure node 1 may correspond to the discussion 1 (e.g., claim 1) of the first text (e.g., the claims). The same-level structure node 1.1 may correspond to key point 1 (e.g., technical feature 1) of the discussion 1. The same-level structure node 1.2 may correspond to key point 2 (e.g., technical feature 2) of the discussion 1. The same-level structure node 1.3 may correspond to key point 3 (e.g., technical feature 3) of the discussion 1.

As previously mentioned, each structure node may correspond to a text unit. The type of the text unit refers to the form of the content of the text unit, for example, a figure number, a drawing description, a summary, a definition, an operation, an example, an extension, a beneficial effect, a formula, a standard expression, or others. As shown in FIG. 4, the type of text unit 1 of “content of summary” corresponding to the superior-level structure node 1 may be [summary] (not shown), the type of text unit 1.1 of “content of step 210” corresponding to the same-level structure node 1.1 may be [operation], and the types of text unit 1.2 and text unit 1.3 corresponding to the same-level structure node 1.2 and the same-level structure node 1.3, respectively, may be [algorithm]. In some embodiments, the type of the text unit may be obtained by manual input or manual selection, or by a classification model based on a structure node.

The related requirements of the text unit refer to informative and annotative text of the content of text unit, such as details, notes or reference contents, or the like. For example, if the related requirement of the text unit 1 of “summary” corresponding to the superior-level structure node 1 is [describe in detail], the related requirement of the text unit of “content of step 210” corresponding to the same-level structure node 1.1 may be [describe in detail, the related requirements of the text unit 1.2 and text unit 1.3 corresponding to same-level structure node 1.2 and same-level structure node 1.3, respectively, may be also [describe in detail]. In some embodiments, the related requirements of the text unit may be obtained by manual input.

In some embodiments, the content features of the structure nodes may also include a key point type feature.

The key point type feature refers to an attribute of a key point type. For example, type features of the key point 1, i.e., “production of an enterprise,” and key point 2, i.e., “sales performance of an enterprises,” of the above-mentioned enterprise analysis report may be data. For example, if the key point of the patent application document may include technical features, the type features of the technical features may include model structures, algorithms, materials, components, structures, etc.

In some embodiments, the key point type feature may be obtained by a key point type judging model. In some embodiments, the key point type judging model may be a machine learning model.

In some embodiments, the key point type judging model may include an embedded sub-model and a classification sub-model.

In some embodiments, the embedded sub-model may generate a vector representing a key point text (also referred to as key point text representing vector) based on a key point. Specifically, the embedded sub-model may vectorize words in the key point text to acquire word vectors, and then determine the key point text representing vector based on the acquired word vectors. In some embodiments, the embedded sub-model may include, but not limited to: a Word2vec model, a Term Frequency-Inverse Document Frequency (TF-IDF) model, a skip-gram based combined-sentiment word embedding (SSWE-C) model or a neural network model, or the like.

In some embodiments, the classification sub-model may generate a key point type feature based on the key point text representing vector. Specifically, the classification sub-model may map the input key point text representing vector to a value or a probability, and obtain the key point type feature based on the value or probability. In some embodiments, the classification sub-model may be, but not limited to, a logistic regression model, a simple Bayesian classification model, a Gaussian distribution Bayesian classification model, a decision tree model, a random forest model, a KNN classification model, a neural network model, or the like.

As above mentioned, the input of the structure node generating model may include the content features of the superior-level structure node or the same-level structure node to be generated, and output of the structure node generating model may be a structure node. Specifically, the structure node generating model may vectorize the content features of the superior-level structure node or the same-level structure node, encode the vectorized content features of the superior-level structure node or the same-level structure node to obtain a semantic vector that fuses the content features, and then acquire the structure node based on the semantic vector.

As shown in FIG. 4, the superior-level structure node 1 may correspond to the discussion, so there may be no key point type feature. The key point type feature of the same-level structure node 1.1 may be [data], the key point type features of the same-level structure node 1.2 and the same-level structure node 1.3 may be [structure].

In summary, with FIG. 4 as an example, assuming “step 220” is a structure node to be generated, the content features of the superior-level structure node 1, the content features of the same-level structure node 1.1, the content features of the same-level structure node 1.2, and the content features of the same-level structure node 1.3 may be inputted into the structure node generating model to output the structure node of “step 220”. The content features of the same-level structure node 1.1 may include the discussion ([claim 1]), the type of the text unit “content of summary” of ([summary]), and the related requirement ([describe in detail). The content features of the same-level structure node 1.1 may include the key point ([technical feature 1]), the type of text unit “content of step 210” ([operation]), the related requirement ([describe in detail]), and the key point type feature ([data]). The content features of the same-level structure node 1.2 may include key point ([technical features 2]), the type of text unit “content of step 220” ([algorithm]), the related requirement ([describe in detail]), the key point type feature ([structure]). The content features of the same-level structure node 1.3 may include key points ([technical features 3]), the type of text unit “content of step 230” ([algorithm]), the related requirement ([describe in detail]), and the key point type feature ([structure]).

In some embodiments, the structure node generating model may include, but not limited to, a bidirectional long short-term memory, a bi-LSTM model, an Embedding from language model (Elmo), a Generative Pre-Training (GPT) model or a Bidirectional Encoder Representation from Transformers (BERT) model.

In some embodiments, the structure node generating model may be trained based on a large number of labeled training samples. Specifically, the labeled training samples may be inputted into a preliminary structure node generating model, and parameters of the preliminary structure node generating model may be updated by training.

In some embodiments, the training samples may be content features of the superior-level structure node and content features of the same-level structure node of a sample structure node. In some embodiments, a label may be a sample structure node. In some embodiments, the training samples and labels may be obtained by manual input, reading storage data, calling related interfaces, or other ways based on the completed document.

In some embodiments, a common method (e.g., a gradient descent algorithm) may be used to perform model training based on the training sample. In some embodiments, the training process may end when the trained model meets preset conditions.

The above embodiment may have at least one technical effect of the followings: (1) based on the first text, high quality text structure can be obtained through the neural network model, (2) based on the type of the text unit and requirements of the second text set by the user, the text structure which is not meet the set condition can be filtered out and thus the generated text structure is controllable.

FIG. 6 is a flowchart illustrating an exemplary method for editing a text unit according to some embodiments of this disclosure. As shown in FIG. 6, method 600 for editing the content of the text unit may include the following steps:

In step 610, a plurality of neighboring text units of a target text unit may be displayed.

As previously mentioned, the user interface of the client may display the target text unit obtained by the server.

In some embodiments, the user interface may display a plurality of neighboring text units of the target text unit. Specifically, the client may send a request of acquiring a plurality of neighboring text units to the server based on the content of the target text unit, and receive and display the plurality of neighboring text units obtained from the data base by the server based on the request. If the client stores the neighboring text units, the neighboring text unit may be read and displayed directly. As shown in FIG. 7a, the client may display last text unit “content of step 210” and next text unit “content of step 230 content” based on the target text unit of “content of step 220”.

In some embodiments, the client may display the related information of the selected current text unit in the user interface based on the selecting operation on a text unit by a user through the client. The related information may be information used for prompting the user and relating to a current text unit. In some embodiments, the related information may include content features of current structure corresponding to the current text unit and user's modification annotations corresponding to the current text unit. As shown in FIG. 7a, the user may select “content of step 220” as the current text unit on the page of text unit of the client, and the user interface may display the related information of the current text unit. The related information of the current text unit may include the content features of current structure node of “step 220”, and the user's modification annotation for the current text unit. It should be understood that the user may refer to the related information of the text unit when inputting a modification instruction. Related descriptions of the modification instruction may be found in step 620, and details may not be described herein.

In step 620, a modification instruction to the target text unit may be obtained.

In some embodiments, the client may obtain the user's modification instruction to the target text unit. The modification instruction may include editing an unedited blank content in the text unit, thus obtaining an initial version of the second text. The modification instruction may include an editing edited content in the text unit. It may be understood that one modification may correspond to a version of the second text.

In step 630, after performing the modification instruction, an updated target text unit may be displayed.

After the client executes the modification instruction, the user interface may display the target text unit whose content is updated (e.g., modified).

If the content of the target text unit that obtained by the client and displayed by the user interface may be blank, after the client obtains “in step 220” of the target text unit which is input by the user, the client displays the content of the target text unit, that is, “in step 220”.

In some embodiments, the client may send a version of the current second text to the server based on a saved trigger condition.

In some embodiments, the saved trigger condition may be a preset time interval. Specifically, the client may automatically obtain the content of the second text at the current time based on the preset time interval, and send the current version of the second text to the server.

In some embodiments, the saved trigger condition may also be an operation that the client may detect a saved version of the second text by the user. Specifically, after the client receives a saving instruction triggered by the user, the current version of the second text may be sent to the server.

After receiving the current version of the second text from the client, the current version of the second text may be stored in the data base. In some embodiments, the server may only store the initial version and the latest version of the second text, or all versions of the second text.

In some embodiments, the client may display the differences of versions of the text structure and the differences of versions of the text unit. In some embodiments, the user may select multiple versions of the second text to display differences therebetween through the client. In some embodiments, the client may automatically select the latest version and the last version of the second text after receiving the instruction of displaying the differences triggered by the user. Specifically, the client may send a request of acquiring differences of a plurality of versions of the text structure and/or differences of a plurality of versions the text unit of the second text to the server. After receiving the request, the server may call the plurality of versions of the second text from the data base, and determine a plurality of differences of versions of the text structure and/or the differences of versions of the text unit of the second text.

The client may display the differences of versions of the plurality of text structures of the second text provided by the server and/or differences of versions of the text unit. As shown in FIG. 7b, the current version of the text structure and the historical version of text structure may be displayed in the text structure page based on the selecting operation of the client. Further, by comparing the current version of the text structure and historical version of the text structure, the difference of the two versions may be obtained.

In some embodiments, the client may display the differences between a version with the other versions in the form of comments on the second text of the version. As shown in FIG. 7c, based on the user's selection operation on the client, the difference between the current version of the text unit and the historical version of the text unit may be displayed in the text unit page in the form of comments.

The above embodiment may have at least one technical effect of the followings: (1) the text unit editing interface may display a corresponding relationship of the text structure node and the text unit, and the corresponding relationship can help the user to locate corresponding contents quickly, thereby improving efficiency for document editing, (2) based on user's selection, the text unit editing interface may display differences of versions of the text structure and the text unit, which is convenient for the user to learn and summarize, thereby improving capability of document editing for the user, (3) the client may automatically save the versions, so that the historical versions may be retrieved based on the user's selection.

The embodiments of present disclosure may also provide a computer readable storage medium. The storage medium may store computer instructions, and when the computer reads the computer instructions in the storage medium, the computer may implement the above-mentioned method for assisting document editing.

It should be noted that the beneficial effects of different embodiments may be different. In various embodiments, the beneficial effects may be any one or more of the above, or any combinations thereof, or any other beneficial effect may be obtained.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Meanwhile, certain terminology has been used to describe embodiments of the present disclosure. For example, the terms “one embodiment,” “an embodiment,” and/or “some embodiments” mean that a particular feature, structure or characteristic described in connection with the embodiment is in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures or characteristics may be combined as suitable in one or more embodiments of the present disclosure.

Moreover, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “data block,” “module,” “engine,” “unit,” “element” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Moreover, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in smaller than all features of a single foregoing disclosed embodiment.

In some embodiments, the numbers expressing quantities or properties used to describe and claim certain embodiments of the disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the disclosure are approximations, the numerical values set forth in the specific examples are reported as precisely as practicable.

Each of the patents, patent disclosures, publications of patent applications, and other material, such as articles, books, disclosures, publications, documents, things, and/or the like, referenced herein may be hereby incorporated herein by this reference in its entirety for all purposes, excepting any prosecution file history associated with same, any of same that may be inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

Finally, it is to be understood that the embodiments of the disclosure disclosed herein are illustrative of the principles of the embodiments of the disclosure. Other modifications that may be employed may be within the scope of the disclosure. Thus, by way of example, but not of limitation, alternative configurations of the embodiments of the disclosure may be utilized in accordance with the teachings herein. Accordingly, embodiments of the present application are not limited to that precisely as shown and describe.

1. A method for assisting document editing, applied to a client, comprising:
receiving and displaying a text structure of a second text obtained by a server based on a first text, wherein
the first text includes at least one discussion, each of the at least one discussion including at least one key point;
the text structure of the second text is a tree structure, and includes at least one structure node corresponding to the at least one discussion or the at least one key point, the at least one structure node being generated by manual input or by a structure node generating model; wherein
the structure node generating model is a machine learning model, whose input feature includes content features of a superior-level structure node of the at least one structure node and content features of a same-level structure node of the at least one structure node, the content features of the superior-level structure node or the content features of the same-level structure node including one or more features of the superior-level structure node or the same-level structure node: a corresponding discussion, a corresponding key point, a type of a corresponding text unit, or a related requirement of the corresponding text unit, of the superior-level structure node or the same-level structure node; and
the second text includes at least one text unit corresponding to the at least one structure node, the at least one text unit being configured to illustrate the first text;
generating a request of acquiring a target text unit corresponding to the at least one structure node when the at least one structure node is detected to be triggered, and sending the request to the server; and
receiving and displaying the target text unit obtained by the server.

2. The method of claim 1, wherein the content features of the superior-level structure node or the content features of the same-level structure node further include:
a key point type feature of the key point corresponding to the superior-level structure node or the same-level structure node, wherein
the structure node generating model is a neural network model, and is generated by training.

3. The method of claim 2, wherein
the key point type feature is obtained by a key point type judging model, wherein
the key point type judging model is a machine learning model, and includes an embedded sub-model and a classification sub-model;
the embedded sub-model generates a key point text representing vector based on a key point text; and
the classification sub-model generates the key point type feature based on the key point text representing vector.

4. The method of claim 1, further comprising:
displaying a plurality of neighboring text units of the target text unit;
obtaining a modification instruction to the target text unit; and
displaying an updated target text unit after performing the modification instruction.

5. The method of claim 4, further comprising:
based on a saved trigger condition, sending a current version of the second text to the server;
displaying differences of a plurality of versions of the text structure of the second text provided by the server; and
displaying differences of a plurality of versions of the text unit of the second text provided by the server.

6. A system for assisting document editing, comprising:
a text structure receiving module configured to receive and display a text structure of a second text obtained by a server based on a first text, wherein
the first text includes at least one discussion, each of the at least one discussion including at least one key point;
the text structure of the second text is a tree structure, and includes at least one structure node corresponding to the at least one discussion or the at least one key point, the at least one structure node being generated by manual input or by a structure node generating model; wherein
the structure node generating model is a machine learning model, whose input feature includes content features of a superior-level structure node of the at least one structure node and content features of a same-level structure node of the at least one structure node, the content features of the superior-level structure node or the content feature of the same-level structure node including one or more features of the superior-level structure node or the same-level structure node: a corresponding discussion, a corresponding key point, a type of a corresponding text unit, or a related requirement of the corresponding text unit, of the superior-level structure node or the same-level structure node;
the second text includes at least one text unit corresponding to the at least one structure node, the at least one text unit being configured to illustrate the first text;
a text unit requesting module configured to generate a request of acquiring a target text unit corresponding to the at least one structure node when the at least one structure node is detected to be triggered, and configured to send the request to the server; and
a text unit displaying module configured to receive and display the target text unit obtained by the server.

7. The system of claim 6, wherein:
the content features of the superior-level structure node or the content features of the same-level structure node include a key point type feature of the key point corresponding to the superior-level structure node or the same-level structure node, wherein
the structure node generating model is a neural network model, and is generated by training.

8. The system of claim 7, wherein:
the key point type feature is obtained by a key point type judging model, wherein
the key point type judging model is a machine learning model, and includes an embedded sub-model and a classification sub-model;
the embedded sub-model generates a key point text representing vector based on a key point text; and
the classification sub-model generates the key point type feature based on the key point text representing vector.

9. The system of claim 6, wherein the text unit displaying module is further configured to:
display a plurality of neighboring text units of the target text unit;
obtain a modification instruction to the target text unit; and
display an updated target text unit after performing the modification instruction.

10. The system of claim 9, further comprising:
a second text sending module configured to send, based on a saved trigger condition, a current version of the second text to the server, wherein
the text unit displaying module is further configured to:
display differences of a plurality of versions of the text structure of the second text provided by the server; and
display differences of a plurality of versions of the text unit of the second text provided by the server.

11. A computer readable storage medium storing computer instructions, wherein when executed by a processor, the computer instructions direct the processor to perform the method of claim 1.

12. A method for assisting document editing, applied to a server, comprising:
obtaining a first text, the first text including at least one discussion, each of the at least one discussion including at least one key point;
obtaining a text structure of a second text based on the first text, wherein
the text structure of the second text is a tree structure, and includes at least one structure node corresponding to the at least one discussion or the at least one key point, the at least one structure node being generated by manual input or by a structure node generating model generation; wherein
the structure node generating model is a machine learning model, whose the input feature includes content features of a superior-level structure node of the at least one structure node and content features of a same-level structure node of the at least one structure node, the content features of the superior-level structure node or the content feature of the same-level structure node including one or more of features of the superior-level structure node or the same-level structure node: a corresponding discussion, a corresponding key point, a type of a corresponding text unit, or a related requirement of the corresponding text unit, of the superior-level structure node or the same-level structure node;
the second text includes at least one text unit corresponding to the at least one structure node, the at least one text unit being configured to illustrate the first text;
sending the text structure of the second text to a client;
receiving a request of acquiring a target text unit corresponding to the at least one structure node generated by the client; and
in response to the request, obtaining the target text unit and sending the target text unit to the client.

13. The method of claim 12, further comprising:
receiving a current version of the second text from the client;
determining differences of a plurality of versions of the text structure of the second text and sending them to the client; and
determining differences of a plurality of versions of the text unit of the second text and sending them to the client.

14. A system for assisting document editing, comprising:
a first text obtaining module configured to obtain a first text, the first text including at least one discussion, each of the at least one discussion including at least one key point;
a text structure generating module configured to obtain a text structure of a second text based on the first text, wherein
the text structure of the second text is a tree structure, and includes at least one structure node corresponding to the at least one discussion or the at least one key point, the at least one structure node being generated by manual input or by a structure node generating model generation; wherein
the structure node generating model is a machine learning model, whose the input feature includes content features of a superior-level structure node of the at least one structure node and content features of a same-level structure node of the at least one structure node, the content features of the superior-level structure node or the content feature of the same-level structure node including one or more features of the superior-level structure node or the same-level structure node: a corresponding discussion, a corresponding key point, a type of a corresponding text unit, or a related requirement of the corresponding text unit, of the superior-level structure node or the same-level structure node;
the second text includes at least one text unit corresponding to the at least one structure node, the at least one text unit being configured to illustrate the first text;
a text structure sending module configured to send the text structure of the second text to a client;
a request receiving module configured to receive a request of acquiring a target text unit corresponding to the at least one structure node generated by the client; and
a text unit sending module configured to, in response to the request, obtain the target text unit and send the target text unit to the client.

15. The system of claim 14, further comprising:
a second text obtaining module configured to receive a current version of the second text from the client; and
a version difference determining module configured to determine differences of a plurality of versions of the text structure of the second text and send them to the client, and determine differences of a plurality of versions of the text unit of the second text and send them to the client.

16. A computer readable storage medium storing computer instructions, wherein when executed by a processor, the computer instructions direct the processor to perform the method of claim 12.
